(19) United States
(12) Patent Application Publication
(10) Pub. No.: US 2004/0036682 A1
(43) Pub. Date: Feb. 26, 2004

(54) Stylus UI system and stylus

(76) Inventor: Sachi Mi Zobuchi, Tokyo (JP)

Correspondence Address: Robert H. Kelly, Scheef & Stone, L.L.P., Suite 1400, 5956 Sherry Lane, Dallas, TX, 75225, US

(21) Appl. No.: 10/465,037

(22) Filed: Jun. 19, 2003

(30) Foreign Application Priority Data
Jun. 26, 2002 (JP) JP2002-186802

(51) Int. Cl. G09G 5/00

(52) U.S. Cl. 345/179

(57) ABSTRACT

A stylus UI system which has greatly improved the customarily employed pen-input UI system, enabling the user to intuitively comprehend the stylus UI system, to use them very easily through simple operation without error, and the context menu to be very easily accessible. The stylus UI system includes a stylus having a plurality of tip portions for touching a touch-sensitive panel, and RF-IDs corresponding to the tip portions; and a unit body including position detector means connected to the stylus through the RF-IDs in a wireless manner to detect a touch position on the touch-sensitive panel, RF-ID read means for reading the data stored in the RF-IDs, and control means for executing the operation inclusive of the control operation upon obtaining the data.

### BACKGROUND OF THE INVENTION

1. Field of the Invention

This invention relates to a stylus which is an input device of the pen UI (user interface) type used for a touch-sensitive panel and to a UI system including the above stylus. More specifically, the invention relates to a stylus UI system in which a stylus (accessory unit) is connected to a computer (unit body) in a wireless manner.

The stylus UI system is used for touch-sensitive panels such as tablet or touch-sensitive screens or displays in order to input coordinates or positions, and is widely employed for small PDAs for which use of the mouse or keyboard involves difficulty.

2. Description of the Related Art

In recent years, almost all computer control systems based upon the GUI (graphical user interface) are furnished with context menus which are pop-up menus offering menu items that can be utilized in a variety of situations.

When a system based on, for example, the MS Windows is used, the context menu can be displayed on the screen by clicking the right button of the mouse. The context menu tells the user which operations are now utilizable and, further, enables the user to make a quick access to the menu items that can be used.

To displaying the context menu, there can be used a pen UI device of the conventional pen input type which displays the contetext menu when the input pen stays in touch with the display for longer than a predetermined period of time (long touch). There is another pen UI device having a particular button provided on the grip of the input pen, the button corresponding to the right button click of a general mouse for displaying the context menu.

However, the conventional input systems based on the pen UI device system involve various problems.

That is, the user who is not accustomed to the use may intuitively find it difficult to use the long-touch activation for displaying the context menu on the screen, or may not quite notice even the presence of such functions.

A sufficiently long time difference has been imparted to the touch time for activating the context menu to clearly distinguish the short touch over the long touch, and the long touch has been set to possess a longer time. In this case, however, the user is requested to wait for a white until the menu appears and is, hence, requested to interrupt the continuing operation. This often results in the occurrence of undesired activation, such as causing the user to fail to open the context menu, to effect incorrect activation or to open an undesired context menu. Another conventional pen-type input device having a special input pen with a button on the grip portion is always accompanied by a probability that the button may undesirably be touched. Therefore, the user faces a highly probable risk.

### SUMMARY OF THE INVENTION

This invention was accomplished in view of the above problems, and has an object of providing a stylus UI system and a stylus which can be used by the user very easily through simple operation without error and which can be understood intuitively. In particular, the invention also has an object of providing a stylus UI system with which the context menu is accessible very easily and quickly through a simple operation.

In order to solve the above problems and to achieve the desired object, a stylus and a stylus UI system according to the invention are constituted as described below.

Namely, a stylus UI system comprising:

a stylus having a plurality of tip portions for touching a touch-sensitive panel, and RF-IDs corresponding to the tip portions; and

a unit body including position detector means connected to the stylus through the RF-IDs in a wireless manner to detect a touch position on the touch-sensitive panel, RF-ID read means for reading the data stored in the RF-IDs, and control means for executing the operation inclusive of the control operation upon obtaining the data.

The stylus may include a main portion that is gripped during the use and a plurality of tip portions arranged facing outward from the main portion and being separated apart from each other.

Among the plurality of tip portions, the one may be used for the access of the context menu.

The stylus can be constituted without having a power source such as battery, rechargeable cell or AC adapter. It is further desired that the RF-ID read means is incorporated in the unit body, i.e., in the electronic equipment or the computer body. It is, however, also allowable to design the RF-ID read means as an independent read unit possessing an independent power source.

A stylus comprises a plurality of tip portions for touching a touch-sensitive panel, data storage means for storing the data corresponding to the tip portions, and energy-receiving means for receiving drive energy in a non-contacting manner from an external unit, wherein the data are transmitted by using the received energy.

As a method of receiving the drive energy in a non-contacting manner from an external unit, there can be employed a laser method, an RF wave method or a magnetic field method, and it is desired that the stylus is constituted without the power source.

### BRIEF DESCRIPTION OF THE DRAWINGS

FIG. 1 is a view schematically illustrating a stylus having two tip portions according to an embodiment of the invention;

FIG. 2 is a diagram illustrating the constitution of a stylus UI system including the stylus and the unit body according to the embodiment of the invention;

FIG. 3 is a flowchart illustrating the flow of operation of the stylus UI system according to the embodiment of the invention; and

FIGS. 4A and 4B are views illustrating a state where the stylus UI system of the invention is being used by a user.

### DETAILED DESCRIPTION OF THE INVENTION

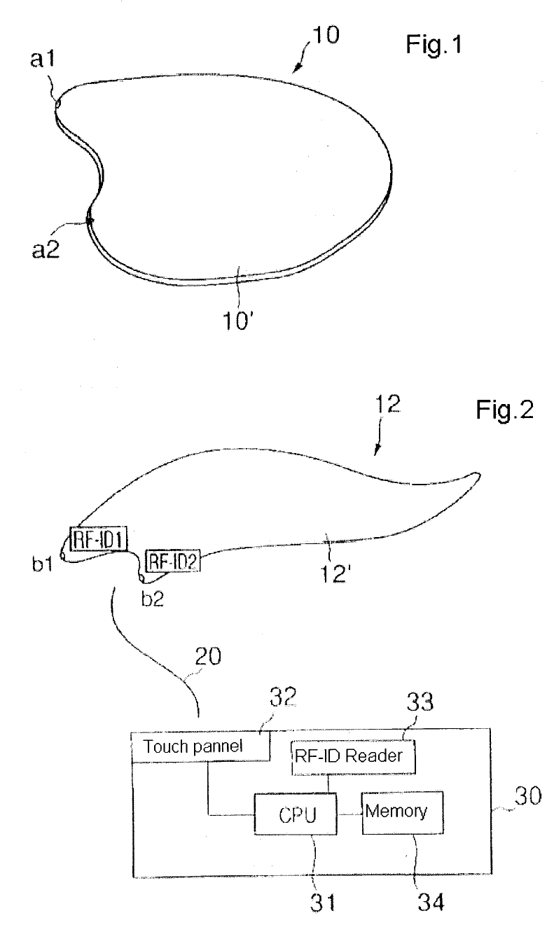

A stylus and a stylus UI system of the invention will now be described in detail by way of an embodiment with reference to FIGS. 1 to 4.

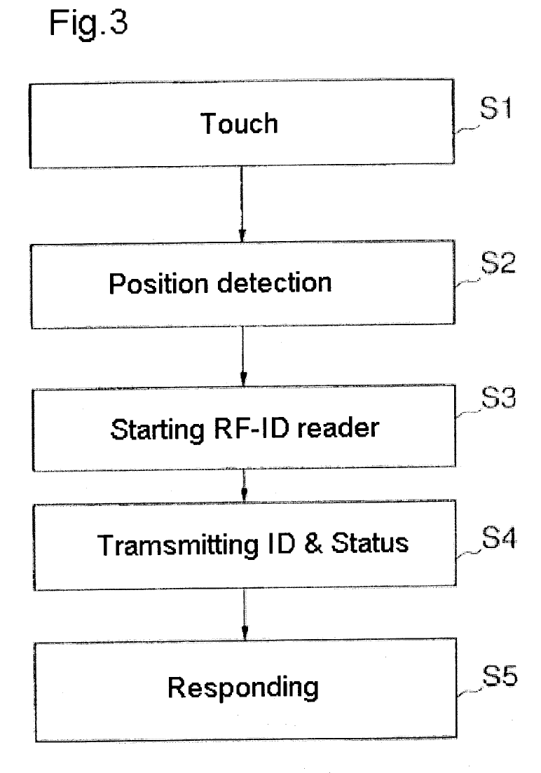

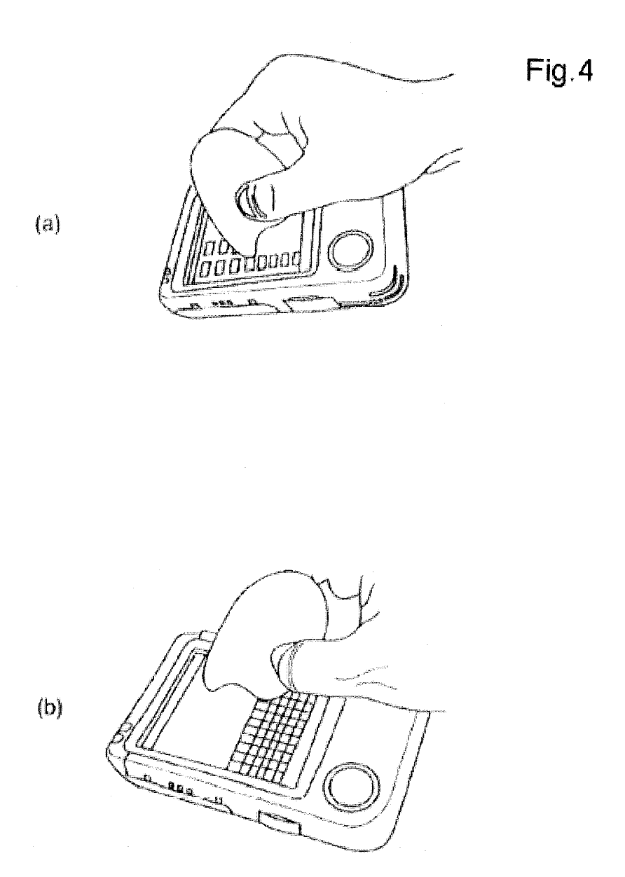

FIG. 1 is a view schematically illustrating a stylus having two tip portions according to an embodiment of the invention, and FIG. 2 is a diagram illustrating the constitution of a system including the stylus and the unit body. FIG. 3 is a flowchart illustrating the flow of operation of the stylus UI system according to the invention, and FIGS. 4 are views illustrating a state where the stylus UI system of the invention is being used, wherein FIG. 4A illustrates a state where a first upper tip portion between the two tip portions is brought into touch onto the panel to point an object, and FIG. 4B illustrates a state where a second lower tip portion is brought into touch onto the panel to activate a context menu.

FIG. 1 illustrates a stylus according to the invention. The stylus 10 has a main portion 10′ of the shape of a thin flat plate with a streamlined circumference, and is gripped by a user by hand or fingers. Therefore, the stylus 10 is designed in a three-dimensional shape that can be easily handled. Further, the side surfaces of the main portion 10′ are slightly protruded and tip portions are arranged at the end portions thereof at a plurality of places. In FIG. 1, there are two tip portions as designated at a1 and a2. The plurality of tip portions have RF-IDs corresponding thereto, the end portions thereof serving as mechanical switches. The tip portions have been protruded to come in touch with the touch-sensitive panel separately from each other, and are desirably arranged being separated from each other facing nearly the same direction on the outer side from the side surface of the main portion 10′ so as to accomplish easy touch.

The three-dimensional shape and arrangement of the stylus 10 including the main portion 10′ and the tip portions (a1 and a2) may be suitably designed by taking into consideration the size and shape of the panel that is used, and the subject displayed on the panel, contents thereof, arrangements thereof and easy use by the user.

FIG. 2 is a diagram illustrating the constitution of a system including a stylus 12 and a unit body 30 according to the invention, wherein the stylus 12 and the unit body 30 are integrally constituted together being connected together through wireless connection means 20 such as the one based on RF-IDs.

The RF-ID used in the present invention stands for ratio-frequency identification which is a system for reading and writing the data written in an electronic circuit such as a card, a label or a tag by using electromagnetic waves or the like.

The unit body 30 has RF-ID read means for recognizing the RF-ID, and an RF-ID reader 33 for executing the reading. Further, the stylus 12 has a plurality of tip portions (b1, b2) on the main portion 12′, and RF-IDs corresponding to the tip portions. Therefore, when the tip portion (b1, b2) has touched the touch panel 32, a signal for specifying the tip portion is transmitted from the RF-ID corresponding to the tip portion, and is recognized by the reader 33 in the unit body 30.

The RF-ID reader 33 included in the unit body 30 alternately repeats the RF-ID scanning, i.e., radiation of electromagnetic waves and reception of electromagnetic waves transmitted from the RF-IDs at all times. The electromagnetic waves have a frequency in the RF band, such as a frequency of about 2.4 GHz. On the side of the stylus 12, the RF-ID converts the electromagnetic waves into drive energy and transmits the stored data again being carried on the electromagnetic waves. In this invention, the RF-ID corresponding to the tip portion (b1, b2) operates only when the tip portion (b1, b2) of the stylus 12 is brought in touch with the touch-sensitive panel 32 by providing a switch which mechanically breaks a portion of the circuit. Thus, there can be provided a switch which mechanically breaks a portion of the circuit. When the tip portion (b1, b2) touches the panel 32, as described above, the RF-ID corresponding to the tip portion (b1, b2) operates, and the key data stored in the RF-ID is transmitted. The RF-ID reader 33 receives the data that is transmitted and converts the received ID into a code corresponding thereto.

The stylus UI system according to the present invention includes the following entities.

Stylus (device corresponding to an input pen):

Mechanical switches at the tip portions.

When the switch is depressed, the status of the RF-ID tag is turned on.

RF-ID tag.

Transmits the respective IDs and status to the unit body.

Unit body.

RF-ID reader.

Detects the RF-IDs and the status.

Softwares corresponding to different inputs.

FIG. 3 is a flowchart illustrating the flow of a process of the stylus UI system according to an embodiment of the invention. Described below are the steps.

Step S1:

The tip portion of the stylus touches the surface of the touch-sensitive panel (display).

Step S2:

The unit body recognizes the fact of being touched and detects the position on the touch-sensitive panel.

Step S3:

The RF-ID reader starts operating.

Step S4:

The RF tag of the stylus transmits the ID and the status (on or off).

Step S5:

The touch panel recognizes which chip portion is turned on, and responds correspondingly thereto.

FIGS. 4 are views illustrating a state where the stylus UI system according to the invention is being used, wherein FIG. 4A illustrates a state where the first upper tip portion between the two tip portions is brought into touch onto the panel to point an object, and FIG. 4B illustrates a state where the second lower tip portion is brought into touch onto the panel to activate a context menu.

In FIGS. 4, the stylus used by the user has two tip portions, and it is very convenient if one tip portion is used for tapping an object and if the other tip portion is used for activating the menu. Here, what the user has to do is to simply vary the angle of the stylus by minutely moving his fingers and wrist. The stylus UI system of the invention can be applied to the pen-type UI computer system based on GUI, and the user is allowed to make an easy and quick access to the context menu while operating the system.

The stylus UI system according to the invention includes a stylus having a plurality of tip portions (protruded portions) with different RF-IDs, and means capable of detecting the plurality of different RF-IDs on the touch-sensitive panel. The user who uses the stylus with two tip portions interacts with the system body by using chiefly the first upper tip portion. When it is desired to make an access to the context menu, the user, then, taps the panel (lightly touches the icon) by using the second lower tip potion to easily fulfil the purpose.

In the stylus UI system according to the embodiment of the invention, the stylus is provided with two tip portions which are arranged back and forth or up and down being separated apart from each other. Here, the context menu can be activated very conveniently by using the second tip portion (on the rear side or on the lower side). The main portion and the plurality of tip portions formed thereon may assume a variety of constitutions in their shapes, degree of protrusion and mutual arrangement, which may be suitably selected and designed no matter what constitution they assume.

When the stylus is provided with two tip portions, the tip portions can be used in a variety of ways other than those described above. Described below are some examples in which the user chiefly uses the first tip portion, and the second tip portion is imparted with other functions.

Shows the candidates of characters for recognizing the hand-writing.

Shows color pallets in an application for writing pictures and figures.

The first tip portion is used for simply displaying menu/icon in an emphasized manner, and the second tip portion is used for opening the object.

The conventional stylus assumed the shape of a pen for writing and incorporated a power source, and could not be designed in a compact shape or could not be freely designed. In the present invention as demonstrated in the embodiment, the stylus itself is very light in weight, has a small thickness, and can be freely designed from the standpoint of easy use.

In this invention, the data of having touched is transmitted by using the RF-ID. When roughly considered, means for executing the system by using the RF-ID according to the invention requires an RF-ID reader on the unit body side and requires the RF-IDs on the stylus side being corresponded to the tip portions. The RF-ID includes means for storing and holding the data, and means for transmitting and receiving data signals.

The RF-ID requires a dedicated reader. The stylus, however, requires no power source since it works on the energy of electromagnetic waves radiated from the reader. In the stylus UI system of this embodiment, therefore, the stylus requires no power source.

However, the RF-ID is capable of transmitting only those data stored in the memory unit on the stylus side. Therefore, the stylus according to the embodiment requires RF-IDs specific to the tip portions. If described most simply, each tip portion may be provided with each RF-ID. Even when the tip portions are formed in many number, each tip portion may be provided with each RF-ID. However, the number of the RF-IDs can be decreased if a plurality of RF-IDs are corresponded to one tip portion, such as operating two RF-IDs upon the touch by one tip portion.

In this embodiment, the features recited in the claims were described by way of constitutions which can be easily comprehended by people skilled in the art. It should, however, be noted that the scope disclosed in this application is in no way limited thereto only but also encompasses all of novel features clearly disclosed therein or that can be implied therefrom, any combination of these novel features, and those that are generalized.

The stylus and the stylus UI system of the invention have greatly improved the customarily employed pen-input UI system, enabling the user to intuitively comprehend the stylus and the stylus UI system, and to use them very easily through simple operation without error. Therefore, the context menu is accessible very easily, quickly and in an easy to understand manner.

1. A stylus UI system comprising:
a stylus having a plurality of tip portions for touching a touch-sensitive panel, and RF-IDs corresponding to the tip portions; and
a unit body including position detector means connected to the stylus through the RF-IDs in a wireless manner to detect a touch position on the touch-sensitive panel, RF-ID read means for reading the data stored in the RF-IDs, and control means for executing the operation inclusive of the control operation upon obtaining the data.

2. A stylus UI system according to claim 1, wherein said stylus includes a main portion that is gripped during the use, and a plurality of tip portions arranged facing outward from the main portion and being separated away from each other.

3. A stylus UI system according to claim 1, wherein among the plurality of tip portions, the one is used for the access of the context menu.

4. A stylus comprising a plurality of tip portions for touching a touch-sensitive panel, data storage means for storing the data corresponding to the tip portions, and energy-receiving means for receiving drive energy in a non-contacting manner from an external unit, wherein the data are transmitted by using the received energy.

5. A stylus according to claim 4, wherein said stylus has no power source.
